(19) United States
(12) Patent Application Publication
(10) Pub. No.: US 2025/0020782 A1
(43) Pub. Date: Jan. 16, 2025

(54) COUPLING DEVICE FOR PHOTOELECTRIC CONVERSION AND LASER RADAR

(71) Applicant: INNOVUSION (SUZHOU) CO., LTD., SUZHOU (CN)

(72) Inventors: Shaocheng Yan, SUZHOU (CN); Lirui Lu, SUZHOU (CN); Siwei Luo, SUZHOU (CN); Yufeng Li, SUZHOU (CN); Ben Du, SUZHOU (CN)

(73) Assignee: INNOVUSION (SUZHOU) CO., LTD., SUZHOU, JS (CN)

(21) Appl. No.: 18/714,555

(22) PCT Filed: Nov. 29, 2022
(86) PCT No.: PCT/IB2022/061507

§ 371 Date: May 29, 2024

(30) Foreign Application Priority Data
Nov. 30, 2021 (CN) 202111440442.4

(51) Int. Cl. G01S 7/481

(52) U.S. Cl. CPC G01S 7/4816; G01S 7/4818

(57) ABSTRACT

The present disclosure discloses a coupling device for photoelectric conversion and a laser radar. The device comprise a light receiving lens, a detector, and a coupling device provided between the light receiving lens and the detector, wherein the coupling device comprises an optical fiber and a lens group arranged coaxially with each other, the optical fiber is arranged near an end with the receiving lens, and the lens group is arranged near the other end with the detector; and the light receiving lens is configured to converge the signal light reflected by a target reflector and couple the converged signal light into an optical fiber, the lens group is configured to receive the signal light output from the optical fiber, and the detector is configured to receive the signal light that passes through the lens group and perform photoelectric conversion on the received signal light.

### CROSS-REFERENCE TO RELATED APPLICATIONS

This application claims priority to Chinese Patent Application No. 202111440442.4, filed Nov. 30, 2021, entitled “A COUPLING DEVICE FOR PHOTOELECTRIC CONVERSION AND LIDAR,” the content of which is hereby incorporated by reference in its entirety.

### TECHNICAL FIELD

The present disclosure relates to the technical field of laser radars, and in particular to a coupling device for photoelectric conversion and a laser radar.

### BACKGROUND

The optical architecture of a laser radar mainly comprises a transmitting system, a receiving system, and a scanning system. In a conventional laser radar, the transmitting system generates laser, which is turned into signal light with different angles and transmitted out of the entire radar by the scanning system. The signal light is reflected when encountering an external object, and the receiving system collects the signal light that returns into the laser radar. The receiving system comprises a light receiving module in which signals are focused on a detector through an optical lens and signal intensity and time information are analyzed by a subsequent circuit, see FIG. 1 for details.

During the transmission of the signal light, the distance between subunits of a detector array is very close, and stray light exists in the system, thus likely causing crosstalk of optical signals and crosstalk of electrical signals between different channels.

### SUMMARY

The present disclosure provides a coupling device for photoelectric conversion and a laser radar to improve the coupling efficiency of the signal light of the laser radar, and to reduce the crosstalk during transmission of the signal light.

In the first aspect, an embodiment of the present disclosure provides a coupling device for photoelectric conversion, comprising:
a light receiving lens, a detector, and a coupling device provided between the light receiving lens and the detector,
the coupling device comprising an optical fiber and a lens group arranged coaxially with each other, the optical fiber being arranged near an end with the light receiving lens, and the lens group being arranged near the other end with the detector;
wherein the light receiving lens is configured to converge the signal light reflected by a target reflector and couple the converged signal light into an optical fiber, the lens group is configured to receive the signal light output from the optical fiber, and the detector is configured to receive the signal light that passes through the lens group and perform photoelectric conversion on the received signal light.

Optionally, at least one coupling device is provided, and each of the coupling devices comprises an optical fiber and a lens group arranged coaxially with each other.

Optionally, the optical fiber has a numerical aperture of >0.2.

Optionally, the lens group comprises a collimating lens and a convergent lens.

Optionally, subunits of the detector are arranged separately from each other by means of electrical isolation.

Optionally, the coupling devices are arranged separately from each other.

In the second aspect, an embodiment of the present disclosure further provides a laser radar, comprising the coupling device for photoelectric conversion as described in any one of the above embodiments of the present disclosure.

In the present disclosure, the coupling device is arranged between the light receiving lens of a light receiving system and the detector of the laser radar, and the optical fiber in the coupling device for photoelectric conversion has a certain optical acceptance angle, so that it can act as a spatial filter to filter out part of stray light inside the laser radar. The signal light passing through the optical fiber passes through the lens coupling device, maximizing the coupling efficiency and reducing the loss of the signal light. The lens group can collimate and converge the signal light without affecting the overall efficiency. The coupling devices are arranged separately from each other to isolate the crosstalk of light. In addition, the detectors are arranged separately from each other by means of electrical isolation, reducing the crosstalk of electrical signals.

### BRIEF DESCRIPTION OF THE DRAWINGS

FIG. 1 is a schematic structural diagram of a receiving system structure of a laser radar in the prior art; and

FIG. 2 is a structural diagram of a coupling device for photoelectric conversion provided in an embodiment of the present disclosure.

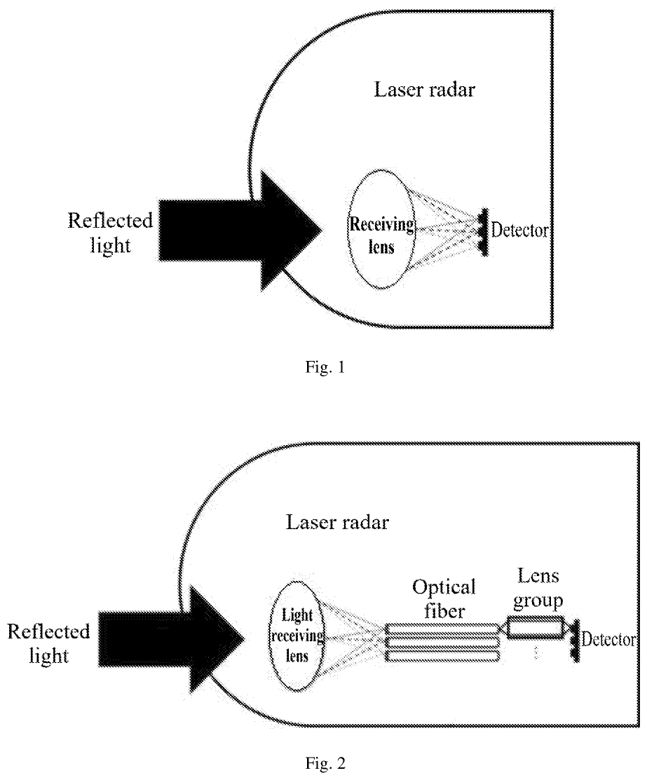

### DETAILED DESCRIPTION OF EMBODIMENTS

The present disclosure is described in further detail below with reference to the drawings and embodiments. It can be understood that specific embodiments described herein are used merely to explain the present disclosure, rather than limit the present disclosure. It should be additionally noted that, for ease of description, only some but not all structures are related to the present disclosure are shown in the drawings.

FIG. 2 is a structural diagram of a coupling device for photoelectric conversion provided in an embodiment of the present disclosure. In this embodiment, signal light entering a receiving system of a laser radar does not converge directly to a detector after passing through a receiving lens. Instead, the signal light is relayed by a corresponding coupling device, and then the coupled signal light is transmitted to the detector.

Specifically, the device comprises a light receiving lens, a detector, and a coupling device provided between the light receiving lens and the detector.

The coupling device comprises an optical fiber and a lens group arranged coaxially with each other. The optical fiber is arranged near an end with the light receiving lens, and the lens group is arranged near the other end with the detector.

Specifically, the reflected signal light enters the laser radar, and is coupled into an optical fiber array through the light receiving lens firstly, that is, the signal light enters the coupling device. The light receiving lens is configured to converge the signal light reflected by a target reflector and couple the converged signal light into an optical fiber. The lens group is configured to receive the signal light output from the optical fiber. The detector is configured to receive the signal light that passes through the lens group and perform photoelectric conversion on the received signal light.

The lens group comprises a collimating lens and a convergent lens, for collimating and converging the signal light output by the optical fiber array. In this embodiment, the coupling between the optical fiber and the detector are realized via the lens.

The device comprises a plurality of coupling devices, and each coupling device comprises an optical fiber and a lens group arranged coaxially with each other. The plurality of coupling devices realize the coupling between the optical fiber array and the detector array, and the plurality of coupling devices are arranged separately from each other and operated in parallel without interfering with each other.

In this embodiment, the optical fiber array formed by a plurality of optical fibers is configured to collect signal light with different field angles. Optionally, the optical fiber has a numerical aperture of >0.2. The optical fiber in the coupling device can act as a spatial filter to filter out part of the stray light inside the laser radar by setting a certain optical acceptance angle, improving the output quality of the signal light as well as the signal-to-noise ratio.

Subunits of the detector are arranged separately from each other by means of electrical isolation, reducing the crosstalk of signal light between different channels and the electrical crosstalk of the subunits of the detector.

An embodiment of the present disclosure further provides a laser radar, comprising the coupling device for photoelectric conversion in the above embodiment.

It is to be noted that only preferred embodiments of the present disclosure and the technical principles employed have been described above. Those skilled in the art will understand that the present disclosure is not limited to the specific embodiments described herein, and various obvious changes, rearrangements and substitutions can be made by those skilled in the art without departing from the scope of protection of the present disclosure. Therefore, although the present disclosure has been described in detail through the above embodiments, the present disclosure is not limited to the above embodiments, and can also include more other equivalent embodiments without departing from the concept of the present disclosure. While the scope of the present disclosure is determined by the scope of the appended claims.

1. A coupling device for photoelectric conversion, comprising:
a light receiving lens, a detector, and a coupling device provided between the light receiving lens and the detector, wherein:
the coupling device comprises an optical fiber and a lens group arranged coaxially with each other,
the optical fiber is arranged near an end with the light receiving lens, and the lens group is arranged near the other end with the detector;
the light receiving lens is configured to converge signal light reflected by a target reflector and couple the converged signal light into the optical fiber,
the lens group is configured to receive the signal light output from the optical fiber, and
the detector is configured to receive the signal light that passes through the lens group and perform photoelectric conversion on the received signal light.

2. The device according to claim 1, wherein the coupling device is one of a plurality of coupling devices provided, and each of the plurality of coupling devices comprises an optical fiber and a lens group arranged coaxially with each other.

3. The device according to claim 2, wherein the optical fiber has a numerical aperture of >0.2.

4. The device according to claim 1, wherein the lens group comprises a collimating lens and a convergent lens.

5. The device according to claim 1, wherein subunits of the detector are arranged separately from each other by electrical isolation.

6. The device according to claim 2, wherein the plurality of coupling devices are arranged separately from each other.

7. A laser radar, comprising a coupling device for photoelectric conversion, the coupling device comprising:
a light receiving lens, a detector, and a coupling device provided between the light receiving lens and the detector, wherein:
the coupling device comprises an optical fiber and a lens group arranged coaxially with each other,
the optical fiber is arranged near an end with the light receiving lens, and the lens group is arranged near the other end with the detector;
the light receiving lens is configured to converge signal light reflected by a target reflector and couple the converged signal light into the optical fiber,
the lens group is configured to receive the signal light output from the optical fiber, and
the detector is configured to receive the signal light that passes through the lens group and perform photoelectric conversion on the received signal light.

8. The laser radar according to claim 7, wherein the coupling device is one of a plurality of coupling devices provided, and each of the plurality of coupling devices comprises an optical fiber and a lens group arranged coaxially with each other.

9. The laser radar according to claim 8, wherein the optical fiber has a numerical aperture of >0.2.

10. The laser radar according to claim 7, wherein the lens group comprises a collimating lens and a convergent lens.

11. The laser radar according to claim 7, wherein subunits of the detector are arranged separately from each other by electrical isolation.

12. The laser radar according to claim 8, wherein the plurality of coupling devices are arranged separately from each other.
